(19) United States
(12) Patent Application Publication
(10) Pub. No.: US 2020/0130830 A1
(43) Pub. Date: Apr. 30, 2020

(54) NEURAL NETWORK-BASED IMAGE TARGET TRACKING BY AERIAL VEHICLE

(71) Applicant: SZ DJI TECHNOLOGY CO., LTD., Shenzhen (CN)

(72) Inventor: Lan DONG, Shenzhen (CN)

(21) Appl. No.: 16/730,038

(22) Filed: Dec. 30, 2019

Related U.S. Application Data
(63) Continuation of application No. PCT/CN2017/091460, filed on Jul. 3, 2017.

(51) Int. Cl. B64C 39/02; G06N 3/08; G05D 1/00

(52) U.S. Cl. CPC B64C 39/024; G06N 3/08; G05D 1/0033; B64C 2201/146; G05D 1/0088; G05D 1/0016; G05D 1/0022; G05D 1/0044

(57) ABSTRACT

A method for controlling an unmanned vehicle includes sensing a trigger event for updating a set of parameters of a remote neural network trained for a respective vehicle context of the unmanned vehicle, receiving from a remote server a set of updated parameters of the remote neural network that at least includes updated connection weights of the remote neural network, and transmitting the updated connection weights to the unmanned vehicle for the unmanned vehicle to operate according to a vehicle-based neural network applying the updated connection weights.

### CROSS-REFERENCE TO RELATED APPLICATION

This application is a continuation of International Application No. PCT/CN2017/091460, filed Jul. 3, 2017, the entire content of which is incorporated herein by reference.

### FIELD OF THE DISCLOSURE

This disclosure relates to operation of unmanned aerial vehicles.

### BACKGROUND OF THE DISCLOSURE

Unmanned Aerial Vehicles (UAV), also known colloquially as “drones”, are becoming increasingly common sights in the skies above sporting and recreational events, natural and man-made landmarks, parks and other features and structures, and, in short, almost anything one might want to get a “bird's eye” view of.

While many may look up to see a UAV in the sky, the UAV is often configured to be looking down, using one or more cameras, whose images are transmitted to a ground-based controller, which may display them for a user. In fact, aerial videography is one of the most common, if not the most common, uses for UAVs.

Some modern UAVs include the ability to adjust their flight paths so as to automatically track imaged objects and keep them in the field of view of their onboard cameras. This not only relieves the user of the need to manually control the UAV to properly follow the object, but it also enables a UAV to track the user himself, who may not even be in a position to safely operate the UAV controller. For example, if a user is riding a bicycle, and he wants his UAV to track him, he will probably not be able to maneuver the joystick(s) normally used to control the UAV's flightpath.

Various tracking routines allow a UAV to identify an object in the field of view of its camera and then maintain its position relative to that object even as the object moves. Often, the user identifies the object by marking it in some way on the display screen of the controller, which then transmits this selection to the UAV. Onboard circuitry and software within the UAV then process the image from its camera to identify that object and define it well enough that its flight control system 1300 can maneuver the UAV so as to keep the object in the camera's field of view.

Identification of objects well enough to allow such continuous tracking requires an image processing capability adequate to extract from an image those pixels that correspond to the object, all in real time. One method that has proven suitable for this task is image processing using a neural network.

Neural networks have been an area of active research in the field of computer science and even pure mathematics for several decades. Although the analogy is sometimes debated, and is imperfect at best, the term “neural network” has been used because the computational structure of such a network is thought to be, at least at a primitive level, similar to the way in which neurons in the human brain processes information. In practice, even the most advanced neural networks typically have a number of internal mathematical connections roughly equal to the number of synaptic connections of a worm, but even this is sufficient for many pattern-matching tasks.

The most common type of neural network is usually represented as “nodes” or “neurons”, arranged in layers. Each node has a value, and forms an output that is fed upwards to one or more nodes in a higher-level layer, usually, but not necessarily, the next highest layer. The value passed from one node upwards to another is usually weighted or otherwise functionally transformed to form the input to the respective higher-level node; the weights or other transformations are usually, but not necessarily, different depending on which higher-level node is to receive it as an input. In other words, a neural network is structured as a graph, where each node connects upwards to zero, one, or more nodes at the next level in the graph.

FIG. 1 illustrates a very simple neural network structure in which there are four layers of nodes Layer0, Layer1, Layer2, and Output, with differing numbers of nodes in each. (A layer may have the same number of nodes as another, however.) Neural networks used even in everyday applications often have many more layers and many more nodes in each layer, sometimes on the order of thousands or even tens of thousands of nodes per layer; this is indicated by the dots to the right of the layers. The neural network illustrated in FIG. 1 is fully connected in the sense that each node feeds its weighted value upwards to each node in the next highest layer. Alternatively, the neural network may be partially connected, either by initial configuration, or, for example, by “disconnecting” a node from the next higher-level node by simply setting its connection weight to zero.

In FIG. 1, the weight of the value from node 0 (leftmost) of Layer0 passed upwards to node 0 of Layer1 is indicated as w_0, 0, 1, 0, and the weight for the fourth node of Layer2 for the connection to the sixth node of the third layer is indicated as w_2,4,3,6. In this example, weights are therefore illustrated as being simple scalar factors or coefficients, but weighting could instead be functional as opposed to purely scalar. As one example of an alternative, the input Inp(n+1) to a node from a node in the immediately lower layer x, whose node value is xn, could be linear, that is, in the form Inp(n+1)=wn*xn+cn, where wn and cn are adjustable coefficients (“weights”).

At the lowest level, the nodes are presented with some set of numerical information and the output from the highest level layer of the neural network is generally used as the “result”. In the illustration in FIG. 1, five inputs are shown as Input0, Input1, Input2, Input3, and Input4, and the output is shown at the top. In some simple neural networks, the result is binary in the sense that it indicates that some condition is either met or not in the input data set. For example, a neural network could be designed to determine if some object is present in an image or not. Other neural network results need not be binary, but can be used to identify more broadly defined features, and may be processed further to determine such things as position within a dataset, to discover patterns, etc.

Neural networks are typically “trained” before they are put into actual use. Training may comprise inputting a number—often a large number—of known datasets and then indicating to the neural network if its current configuration of node-to-node weights has correctly classified each input dataset. If it has not, then various routines are run to allow the neural network to adjust its weights until it correctly classifies all or at least a sufficient number of the known training datasets. For example, a neural network that is intended to identify the presence of boats on the sea could be presented with a large number of input imaging data sets, some containing boats and some not. During training of the neural network, its weights are optimized through known computations so that it will correctly classify these training datasets. The assumption is that the training datasets correspond to the actual conditions in which the neural network will be operating well enough that its results will also be correct when it processes a dataset whose classification is unknown. In the context of UAVs, neural networks may be used to process imaging data so as to help the UAV track objects or otherwise help provide inputs to a flight control system.

An important design consideration for UAVs is their weight, since heavier UAVs will require more powerful propulsion systems and therefore bigger and heavier batteries for a given desired minimum flight time. Similarly, more powerful processing systems will require more power to operate them, and this too will require bigger batteries. Other design considerations such as available space, heat generation, communication bandwidth, etc., also add to the design challenges for UAVs of the size and weight typically preferred in the commercial and recreational markets. Evaluating neural networks, especially in real time, typically involves processing a large number of computations quickly, which makes their use particularly challenging for UAVs that should be as light as possible; many recreational UAVs, for example, have a mass of less than 2.0 kg, less than 1.5, or even less than 1.0 kg, even including the onboard camera.

This problem is made even worse by the large number of coefficient weights that must typically be stored for a given neural network—each memory chip adds to the size of onboard circuitry. One way to solve this problem is for the neural network within a UAV to be fixed, with the weights hard-coded permanently into a non-volatile storage device. This means, however, that it is at best difficult and in many cases impossible to retrain or reconfigure the neural network for other operational contexts without physical replacement or re-coding of that storage device.

It would therefore be advantageous to be able to flexibly adapt a UAV-based neural network without requiring complicated hardware changes.

### BRIEF DESCRIPTION OF THE DRAWINGS

FIG. 1 illustrates a simple neural network.

FIG. 2 illustrates the operation of a UAV together with a remote neural network processing system.

FIG. 3 illustrates the main hardware and software components of a UAV being operated according to embodiments.

FIG. 4 illustrates a display that a user might see while operating a UAV that incorporates embodiments of this disclosure.

FIG. 5 illustrates target selection within a display of a UAV controller.

FIGS. 6 and 7 show examples of neural network selection arrangements that may be used with embodiments.

FIG. 8 illustrates the processing workflow of an embodiment in which neural network parameters are computed and pushed to a terminal.

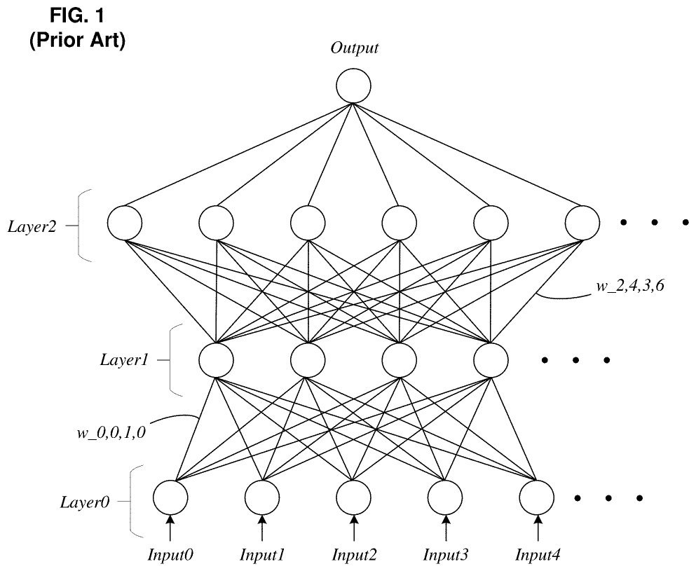

### DETAILED DESCRIPTION

In broad terms, embodiments of this disclosure provide for remote computation of neural network (NN) parameters, which can be loaded into corresponding circuitry within a UAV.

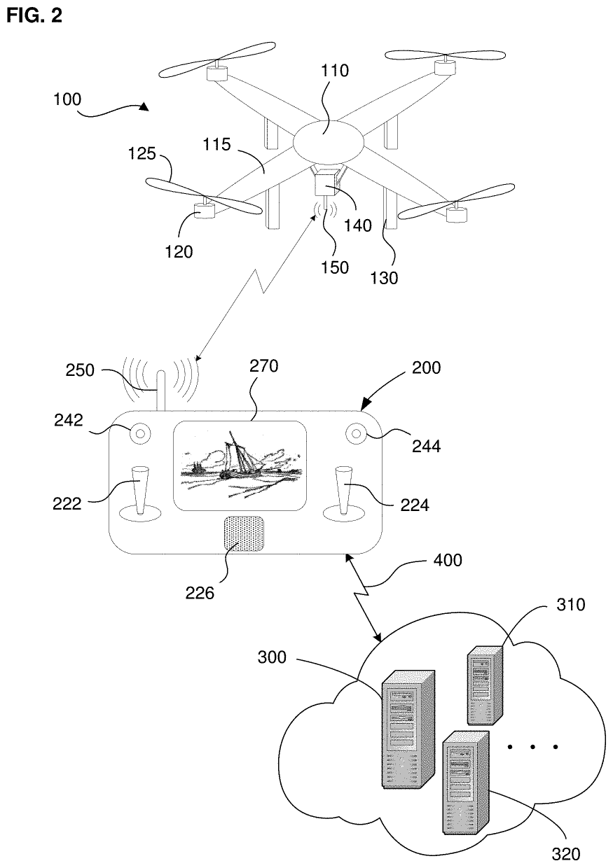

Modern commercial and recreational UAVs take many shapes and forms. FIG. 2 illustrates the main structural features that most of these share. The UAV 100 illustrated in FIG. 2 includes a central body or hub 110 that typically also comprises a housing for the circuitry used to control the UAV. Located on a plurality of supporting structures such as a frame, arms, struts, etc., 115 are respective motors 120, each of which drives at least one propulsion device. As shown in FIG. 2, the propulsion devices are propellers 125, which is the most commonly seen type, although some UAVs have been proposed that used ducted fan arrangements or other alternatives.

Some form of landing gear is generally also provided. In FIG. 2, these are legs 130, although some UAVs have rails, a box frame structure, etc., to make it easier for a user to hold and retrieve the UAV.

One common use of recreational and commercial UAVs is aerial videography. Such UAVs therefore include at least one a camera 140, which may be either fixed or movable, for example, on gimbals with actuators for changing the angle of view. Although still cameras are found on some UAVs, video cameras are more prevalent.

The cameras of many UAVs operate in the visible wavelengths—especially users of recreational and commercial UAVs want to see and record. This disclosure isn't limited to such uses, however; rather, it would be possible to use embodiments described below for thermal tracking, that is, where the camera 140 operates in the infrared region, such as for night-time operation, which many military and police UAVs are configured for.

Although there are some totally autonomous UAVs, especially in advanced uses, most commercial and recreational UAVs are controlled by a user, who operates a controller 200. The UAV therefore includes a wireless communication system such as a radio frequency transmitter with either an internal or external antenna 150.

To fly the UAV and operate its various features, controllers typically include one or more user-operable devices such as joysticks 222, 224, sometimes various buttons 242, 244 not only to turn the controller on and off, but to select other features, and sometimes additional I/O devices such as a trackpad 226. An antenna 250 may be either built into the controller or extend externally to transmit and receive the radiofrequency signals sent to and from the UAV. Although some simple UAVs do not enable a user to view real-time images captured by the camera 140, many do. In such cases, the controller 200 generally includes a display screen 270 on which the user can see images, including video, transmitted down from the UAV. As with many other common devices, the display screen 270 itself may be a touchscreen, such that it too can be used as an input device.

In one embodiment, the controller communicates either in real time or off-line with at least one remote computing system such as a server 300, which may be one of a group of servers 300, 310, 320, . . . . The communication link 400 between the controller and these servers may be through a network, including the Internet, a proprietary network such as a mobile telephone network, or even a hardwired connection, such as a USB or other cable to a local server. Depending on the computational power included in the controller itself, however, it would also be possible to implement some embodiments of this disclosure (described below) using the processing capabilities of the controller itself, with no need for connection to an external processing system. Merely by way of example, embodiments are therefore described below in which the controller 200 communicates over a network 400 with at least one remote server 300.

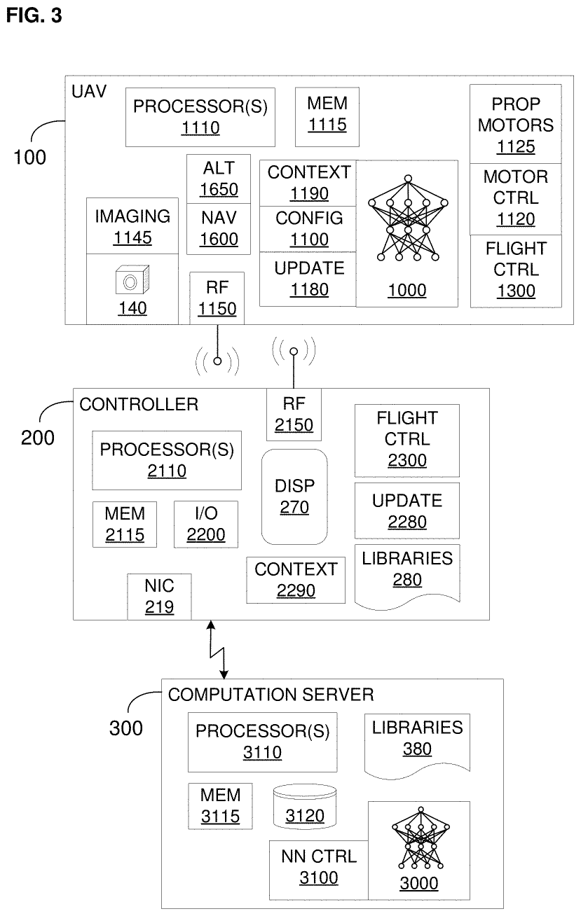

FIG. 3 illustrates the main hardware and software components of the three illustrated systems 100, 200, 300 in FIG. 2. Merely for the sake of clarity, some conventional components such as batteries and other circuitry and software are not illustrated or described, since they are so well known.

At the heart of the circuitry included within the UAV 100 is one or more processors 1110, which may be a known or customized CPU, as well as, in some systems, associated high-speed, specialized devices such as coprocessors, PFGAs, etc. Data and code defining the various software modules within the UAV is stored in one or more devices such as a memory 1115, which may be volatile, including high-speed memory devices, or nonvolatile, such as permanent storage devices, or both. The line between “memory” and “storage” is more and more blurred nowadays by the prevalence of such technologies as SSD and NVRAM, etc. This disclosure does not presuppose any particular memory or storage technology as long as a sufficient amount is made available to satisfy the operational needs of the UAV. Motor control circuitry 1120 is included to control the operation of the motors 1125 that drive the propellers (or other propulsion devices) 125.

Similarly, the camera 140 is controlled by corresponding imaging circuitry and software 1145, which also receives the output from the camera and performs any necessary signal processing to convert the raw image data into a form suitable for further processing and, ultimately, viewing by a user.

Communication with the controller is handled by known radio-frequency circuitry 1150, which may also be considered to comprise the executable code and circuitry necessary to convert and format signals for proper transfer of data and other information to and from the controller 200. Flight control circuitry 1300, which may comprise hardware, firmware, and/or executable code, implements whichever flight control routines and policies that have been designed into the UAV, in accordance with both user commands and internal flight control signals. For example, some UAVs include navigational circuitry 1600 such as GPS, inertial, or other location sensors, as well as, in some products, separate altitude-sensing devices 1650 such as modern, compact MEMS barometers.

In the context of this disclosure, the UAV 100 also includes at least one neural network 1000, which is typically a data structure stored within either volatile or nonvolatile memory 1115. The neural network 1000 is programmable and reconfigurable, for example, under the control of a configuration module 1100. The neural network component may be implemented purely as executable code, that is, as “software”, but it would also be possible to implement at least part of the neural network using hardware devices such as coprocessors; moreover, several companies are now selling ASICs that implement neural networks of varying complexity. It should be possible, however, to change the weights between nodes.

Although FIG. 3 shows “a” neural network 1000, it would also be possible to have more than one configured or available within the UAV at a time. Even in the case of a hardware component to perform the required computations, different sets of weights could be stored in the UAV's memory and selectively loaded, depending on how much memory is included onboard. The UAV may thus be configured to include more than one neural network at a time.

In embodiments of this disclosure, at least one of the neural networks 1000 is used to identify at least one operational state of the UAV for purposes of flight control. Although neural networks may be used to identify a wide range of conditions and patterns, such as operational or other flight state conditions, the embodiment described below will assume by way of example that a purpose of the neural network is to enable the UAV, in particular, its camera 140, to track a selected feature in its field of view. The ability to do this is already known and found in some commercially available UAVs and as such is not described in significant further detail below; rather, embodiments are described in the context of efficiently updating the parameters defining the neural network 1000. These parameters may be both structural and operational.

As used here, “structural parameters” refers to such characteristics as the number of layers in the neural network, the number of active nodes in each layer (that is, nodes that receive at least one non-zero input), and other parameters that define the model or type of the neural network; “computational parameters” refers primarily to the weights assigned to the many node-to-node computational connections in the neural network. Note that these two types of parameters are not necessarily unrelated. For example, depending on how the neural network 1000 is implemented, the number of nodes in each layer could be pre-set to a maximum, but could be altered in practice by setting the weights of unneeded connections to 0. Unless otherwise specified or clear from context, the term “parameters” is used herein to refer to either type, that is, both structural and computational parameters, since either or both types can be selected and updated using embodiments of the disclosure.

The controller 200 will similarly include one or more processors 2110 and one or more memory or storage components 2115 of any chosen technology or mix of technologies. An I/O interface 2200 may receive the inputs provided by the user and translate them into appropriate signals for processing. For example, movement of a joystick may be converted using well-known circuitry and methods into corresponding left-right, forward-backwards, up-down, or other commands. Depending on how the controller 200 is designed to communicate with the external server 300 (if this is the chosen configuration), the controller will include conventional components such as a network interface (NIC) card 219.

The controller 200 will include a wireless communications interface with the UAV 100. In the illustrated example, this is a radio-frequency component 2150. Such devices are found on almost all modern UAVs and are therefore not described further here. As needed, the controller may also include flight control circuitry and software 2300 to convert both automatic and user-directed flight controls and other information into any chosen form suitable for transmission to and interpretation by the UAV. For example, the signals corresponding to physical movement of a joystick 222, 224, may be A/D converted (if necessary), scaled, and formatted, and possibly combined with other control signals for transmission to the UAV, whose own flight control circuitry 1300 may in turn interpret and convert the transmission data into appropriate motor and/or camera commands.

The controller 200 in FIG. 2 is shown as including one or more libraries 280. In some embodiments, these libraries are included to store the computational parameters defining a neural network for different operational contexts. As used here, a “context” is any definition of UAV state that can be parameterized and associated with a programmable neural network configuration. These parameters may then be uploaded to the UAV, which may then load these parameters into its neural network circuitry and software 1000 so as to reconfigure it. Depending on the implementation, reconfiguration could be carried out either when the UAV is at rest, or even in flight in real time.

In FIG. 3, the remote processing system 300 is referred to as a “computation server”, which may be either a single system or a group of processing systems in a distributed environment such as in “cloud processing”. As with other such servers, the computation server 300 will include one or more processors 3110, which may be either general or specialized, as well as both volatile and nonvolatile memory and storage. In FIG. 2, the storage devices are shown separately as 3115 and 3120 simply because the capacity of such remote servers is usually much greater; moreover, the computation server 300, unlike the controller 200, need not be dedicated to the UAV, but could also be handling requests from other systems as well, although this is not required by any embodiment of this disclosure.

The disc-like storage symbol 3120 in FIG. 2 serves to illustrate that the computation server 300 may be used to store a large body of data defining the computational and even structural parameters of many different types of neural networks that could be transferred to the controller 200 for selective uploading to the UAV 100. These various parameter sets may be stored in libraries 380, which are shown separately in the figure, but which will typically be data structures stored within either the memory 3115 or the more permanent but possibly slower storage devices 3120.

Although not illustrated in the figures merely for the sake of simplicity, the UAV, the controller, and the computation server will all include some form of system software and/or firmware, such as an operating system (in the case of the server 300) or more limited and specialized system software customized for the UAV context.

As mentioned above, neural networks are typically “trained” by inputting to them a large number of data sets having known outputs. One or more optimization routines is then run to compute the set of weights that allow the neural network to correctly classify each, or at least a sufficient number of, inputs. The assumption is that, when presented with an input dataset whose output is not known in advance, the neural network will also correctly classify that input dataset. Given the nature of neural networks, however, this assumption is not always proven true in actual operation. This is in part because it is often impossible to know what the neural network's optimization routine has actually converged on, and whether the selected set of weights represents a local or a global optimum.

In one well-known but possibly apocryphal early example of mis-classification, a neural network was trained on a large number of photographs with the purpose of enabling it to identify the presence of vehicles among trees. At the conclusion of the training phase of that neural network, it appeared to correctly classify all of the photographs, as well as photographs that had been reserved as post-training tests. When this neural network was later tested using other photographs, however, it was found that its results were substantially random. Later investigation revealed why: The training photographs that included the vehicles were taken on cloudy days, whereas the photos without tanks were of clear days. As it turned out, what that neural network had been “trained” for was to identify not vehicles, but rather whether the photograph was taken on a cloudy or a clear day. Whether true or apocryphal, this example is still occasionally used to illustrate that neural network training is sometimes unpredictable.

Even with the best training, however, not all possible real-life circumstances or patterns are usually available within training input data sets, such that updating of the neural network is often advantageous to improve classification results. Updating of a neural network generally involves retraining using the entire updated input dataset, although some algorithms exist that can more efficiently and quickly recompute optimal weights given only known inputs in addition to those previously used for training. In either case, whether for initial training or later retraining, the computational burden to optimize a neural network with a given input dataset can be much greater than the processing system in a UAV 100 or even its controller 200 is designed to handle efficiently or at all. Embodiments of this disclosure therefore may leverage the greater processing power and storage capabilities of systems such as the computation server 300.

The server 300 therefore includes a neural network module 3000, which may be implemented as any other body of executable code to perform the known and required computations to optimize the weights and configuration (number of layers; number of nodes in each layer; etc.) of a neural network corresponding to one to be used within the UAV 100. In other words, the neural network module 3000 may be used to compute the parameters of the neural network 1000 used to control certain aspects of the operation of the UAV. A neural network control software module 3100 may be included in at least one of the servers in the remote processing system 300 to direct neural network-related computation tasks and coordinate interactions, such as requests from or pushed downloads to either controllers 200 and/or directly from and to UAVs 100 if the UAVs are configured for such direct communication.

The input data sets for the neural network module 3000 may come from different sources. For example, the vendor of the UAV system may run a large number of flight trials under different circumstances, in different operational contexts, compile corresponding input sets, and present these to the computation server for computation of optimal neural network parameters for the different trial circumstances.

As another nonexclusive alternative, the controller 200 may upload to the computation server 300 imaging data acquired from the UAV that is to be used to update the parameters of the neural network 1000 that the UAV was running when acquiring that imaging data. For example, a user may observe that the UAV too often fails to acquire a selected imaging target or fails to properly track it with its camera even though the UAV supposedly has an appropriate neural network for tracking that target. The actually acquired imaging data may therefore be uploaded to the computation server 300 along with the parameters defining the respective neural network, whereupon the neural network computation module 3000 may recompute the parameters of the neural network given the updated input information. In many cases, this will lead to an improvement of the neural network's ability to correctly acquire and track the intended target type. The computation server 300 may then provide the updated neural network parameters to the controller 200, which may then transfer them by any designed method to the neural network component 1000 of the UAV.

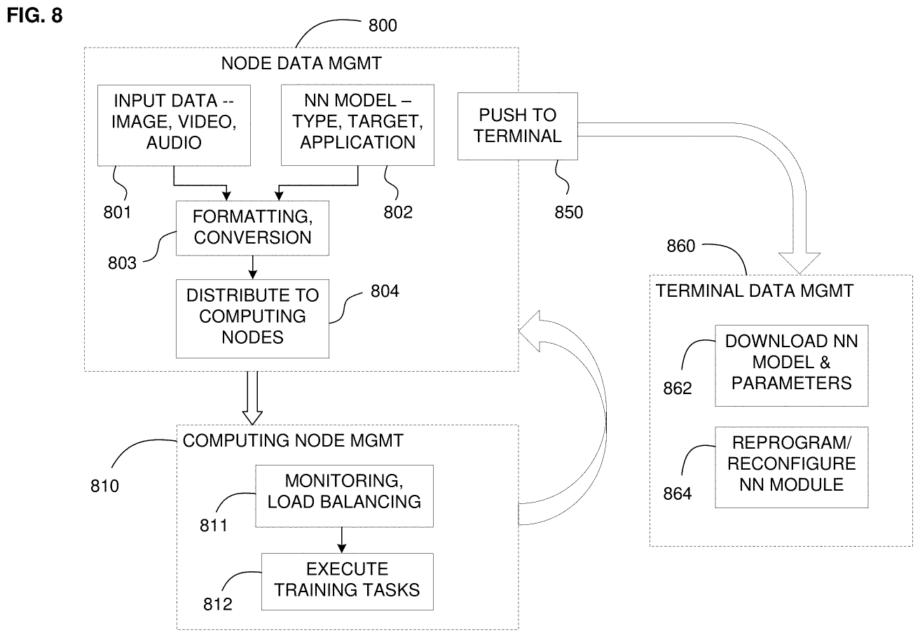

In another embodiment, the UAV 100 may communicate directly with the computation server 300 and directly upload data for retraining and/or receive updated neural network parameters, for example, via a mobile telephone network, if the UAV and computation server are configured with corresponding communication components. An example of a procedure in which neural network parameters are “pushed” to the UAV either directly, or indirectly via the controller 200, is described below with reference to FIG. 8.

As mentioned, video imaging is a common use for UAVs, and neural networks are well-suited for flight control in image-tracking contexts. Embodiments of the disclosure may be used to load and update neural network parameters for other uses, however, or in addition to image-tracking uses. For example, a neural network could be used to detect either desirable or undesirable UAV operational characteristics other than image-tracking. As just one example, a neural network for flight control could be programmed to recognize and compensate for gusty winds, for example, during course-following, non-image-based station keeping, etc. It would also be possible to include one or more neural networks optimized for audio tracking for UAVs that are equipped with a microphone, which could be either general or directional, and possibly be accompanied by noise-cancelling hardware and software.

FIG. 4 illustrates a scene that a user might see on the display 270 while flying a UAV whose real-time video image is downloaded to the controller 200. In the illustrated example, there are four main types of features currently in the field of view of the UAV's video camera: a road, several trees, someone on a bicycle, and a dog. Assume now, again merely by way of example, that the user wishes to track the bicycle. In other words, the user wishes the UAVs flight control system to direct the motion of the UAV such that the bicycle remains in the field of view of the video camera 140. Assuming the bicyclist is moving, this will mean that the neural network 1000 within the UAV needs to acquire the image of the target, that is, of the bicycle, and control the flightpath of the UAV such that this target image remains approximately at the same place within the field of view of the video. This is already within the capability of commercially available UAVs such as some of the products offered by DJI, Inc.

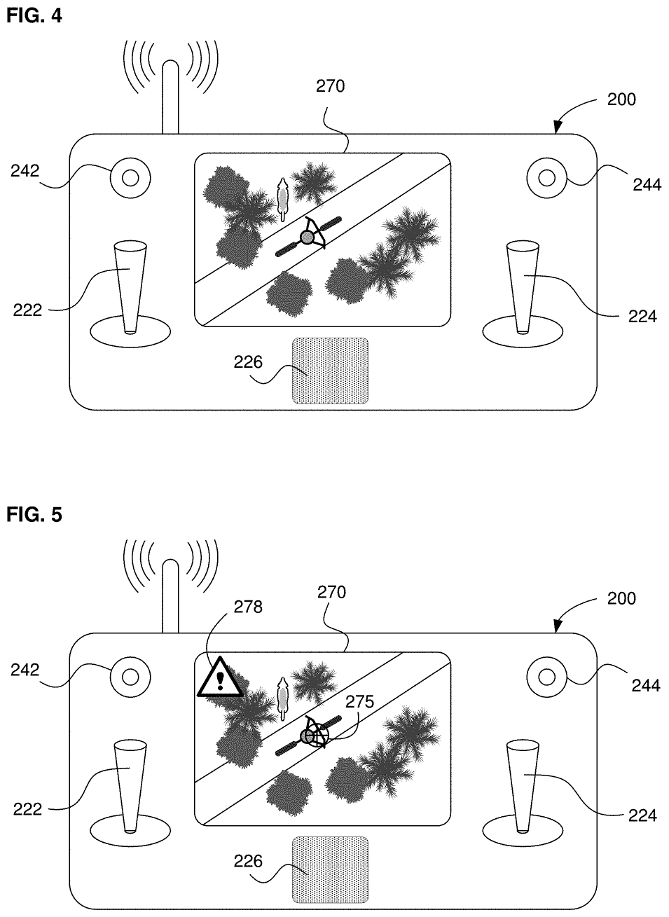

Before the flight control system 1300 of the UAV, taking, as at least one control parameter the output of the neural network 1000, can follow the bicycle, it must of course know that this is what it is supposed to do. FIG. 5 illustrates one way in which this may be accomplished: Using any I/O device such as one of the joysticks 222, 224, the trackpad 226, touching the target image on the display 270, or using any other known method, the user may select the sub-image of the bicycle, for example, by placing a cursor or other indicator 275 on it. The user may then follow any other procedure designed by the vendor to signal to the controller 200 that the chosen sub-image is the target to be tracked. The neural network 1000 or other pattern-matching routine of the UAV may then store a representation of the pixels of the selected sub-image, such that the sub-image can be tracked as it moves. Again, this capability is already available in commercially available UAVs. The UAV may then, depending on the product, confirm acquisition of the target back to the controller and thus user.

Assume, however, that the UAV does not correctly track or even identify the bicycle, that is, acquire the bicycle sub-image. This may represent the “out-of-bounds” situation that the video data being processed by the neural network is being incorrectly classified by the neural network given the parameters it has been programmed with. The user may indicate this tracking failure via the controller 200 in any chosen way such as selecting some icon 278 displayed on the screen, or using any other input method designated by the vendor. It would also be possible for the flight control system within the UAV itself to identify failure to correctly track a target. For example, a target is generally defined by the characteristics of the pixels that correspond to it in the captured image. To find a target, many algorithms use a pattern matching routine that acquires an image target when it finds a pixel region that corresponds to the pattern with at least a threshold degree of correspondence. If the flight control system is unable to find or retain the selected pattern of pixels for an image target, with or without the help of the neural network 1000, then it itself may signal inability to track. This may then be communicated back to the controller 200, which may in turn indicate this to the user in any chosen way, again, for example, by presenting or flashing some icon or other display feature on the screen 270.

The event that triggers updating of the parameters of the neural network 1000 need not be some kind of “failure”, but rather be any event chosen by the user, by the controller 200, by the administrator of the remote processing system 300 or a vendor. Either the UAV, or the controller, or both, may be provided with software update control modules 1180, 2280, respectively, configured to sense and interpret events designed to trigger an update of a neural network; the controller's update module 2280 may also be provided for controlling transfer of the parameters to the corresponding module 1180 in the UAV. As just a few examples, triggering of parameter updating could be according to a schedule, such as a number of elapsed days or completed flights, or renewal of a subscription, or may come from the UAV vendor, which may have released a new library 380 of improved parameters, etc., which may then be “pushed” to one or more UAVs, for example, via their respective controllers 200, or directly, if direct UAV-computation server communication has been included. The user could also simply trigger updating to the controller, for example, before a flight, which may then query the computation server 300 to determine if there is a suitable or updated neural network parameter set. For example, a user may normally use her UAV to video, for example, a particular type of sports matches, but then wishes to video a nature scene and wants to optimize her UAV's flight-tracking ability for that context.

The user may choose not to trigger an update even if tracking fails. For example, the object to be tracked might simply accelerate to a speed that the UAV cannot follow, such that it loses sight of the object. This would not represent any insufficiency on the part of the neural network 1000, which might otherwise have been performing well.

Note also that object movement is not the only reason to need to “track”, that is, to keep the object in position in the field of view of the camera—in most cases, movement is relative, such that the UAV needs to “track”, that is, control its flight trajectory, even when the object itself is stationary. For example, the user may want the UAV to change altitude and/or position while still observing the object, or tracking may be necessary to offset wind-induced drift when the UAV is supposed to “hover” over an object.

Regardless of the cause, acquisition and/or tracking failure may indicate a need to update the parameters of the neural network currently being used within the UAV. The actual image data from the UAV may then be stored by the controller 200 and uploaded to the computation server 300 either in real time, or later. The computation server 300 may then recompute the parameters of the neural network for future use or, depending on radio transmission speed, the controller could even update the UAV's neural network in flight. During the updating procedure, image tracking could be disabled, whereas normal flight control and image viewing and even recording by the user and the video camera could be otherwise unaffected.

Depending on available storage space, it is not necessary that the UAV hold the parameters of only a single neural network. Rather, neural network parameters for different operational situations (“contexts”) could be stored within the UAV and loaded depending on what type of image target a user wishes to track. In other embodiments, the user may be allowed to select the image target, after which the controller uploads, for example, under control of the update % % % to the UAV the parameters for the corresponding neural network best suited (according to any chosen metric) for tracking that type of image target. Those parameters may then be stored either within the libraries 280 of the controller itself, or could be downloaded from the neural network parameter libraries 380 located in the computation server 300. Of course, both libraries could be used. For example, common libraries could be stored within the controller 280, whereas more unusual or vendor-updated libraries could be stored in the computation server for selection and downloading or periodic updating of the libraries 280 in the controller.

Libraries of neural network parameters in the computation server may be either specific to particular UAVs, or could be built up by the accumulated retraining inputs of more than one user. For example, many users may track a bicycle. If other flight characteristics such as UAV model, camera type, altitude, speed, etc., are similar enough, as defined in any predetermined manner, then there could, for example, be a neural network parameter library specifically for tracking bicycles under such conditions, that is, in such a context. The most up-to-date library for that context could then be retrieved by the controller and uploaded to a particular UAV. In other words, one user's UAV could benefit from cumulative retraining based on the experiences of many different users.

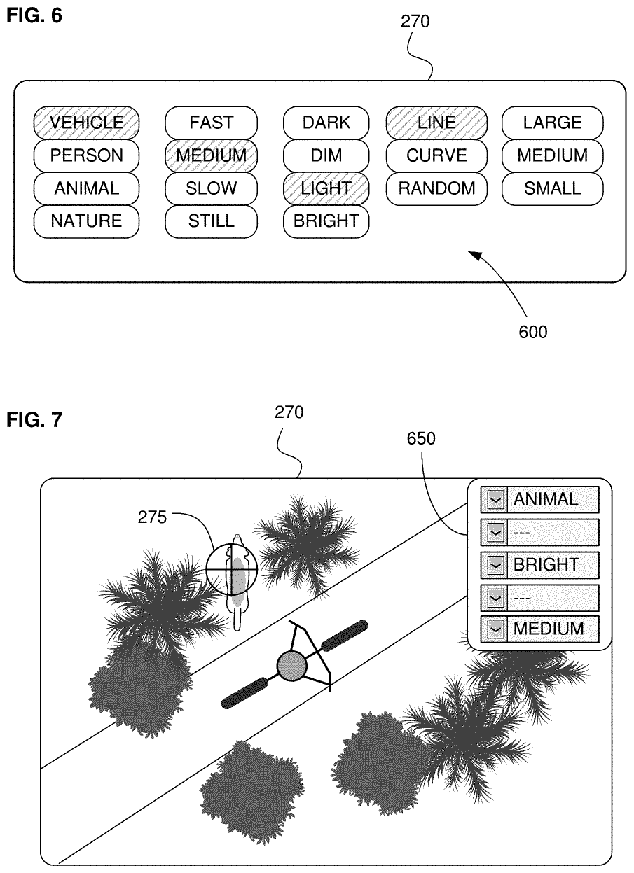

In embodiments that allow a user to indicate to the controller what is to be tracked, using mechanisms, for example, such as those described above, it would also be possible to implement a feature that allows the user to input additional context information, which may be sensed and interpreted by, for example, a context determination module 2290 within the controller. FIG. 6 illustrates one such possibility. In the example shown in FIG. 6, the user, using any known method, indicates to the controller, for example, to the context determination module 2290, the context for which the UAV's neural network 1000 is to be configured, regardless of whether a current tracking target has been selected or not. For example, a user may know that she is going to be video-photographing herself in a river raft, and therefore wishes to select appropriate neural network parameters optimized for tracking such an object.

Although any type and number of context categories could be included, FIG. 6 illustrates, merely by way of example, a selection display 600 that shows five different context categories, each with different selections that, together, may define a “context”. In one category, the user may specify the type of object to be tracked. In this example, VEHICLE, PERSON, ANIMAL, and NATURE are included as selection options. As another category, the user may indicate how fast he believes the object will move, for example, FAST, MEDIUM, SLOW, or STILL. As yet another example category, the user could indicate how bright the imaging area is expected to be, ranging from DARK, to DIM, to LIGHT to BRIGHT. Thus, the neural network of the UAV could have loaded parameters that are different depending on, for example, how cloudy the day is or how strong the sunlight is. Still another possible category could indicate to the UAV what type of trajectory the user expects the tracked object to follow; in the illustration, this could be along a LINE, CURVE, or RANDOM movement. Finally, as illustrated in FIG. 6, the user could indicate whether the object, relative to the display, is LARGE, MEDIUM, or SMALL. It would also be possible for the user simply not to make a selection for any or all of the categories if he does not know well enough to make any recommendation.

Each group of selections the user makes could then be paired with a corresponding parameter set in the library 380 within the computation server 300 or controller (library 280), whereby the corresponding parameters may be downloaded to the controller and uploaded to the neural network 1000 of the UAV before flight, or, depending on upload speed, while in flight.

In FIG. 6, the user, wishing to track the bicycle in FIG. 4, has selected VEHICLE, MEDIUM (size), LIGHT (assuming the day is light but not with strong sun), LINE (corresponding to the observed shape of the road), but he has not indicated the size of the object, perhaps because he does not know which to choose. The controller may then query its own library 280, or the libraries 380 of the computation server 300 to find a corresponding set of neural network parameters to upload to the UAV. Note that this makes available to the neural network of the UAV a potentially large library of configurations and weights with no need for a correspondingly large onboard storage capacity.

As FIG. 7 illustrates, other input methods may be used to allow the user to make category selections. In FIG. 7, this is done via a set of pulldown menus 650, each of which may display the selections for each tracking category; the context determination module 2290, for example, may then input and interpret the selections, and apply the appropriate context to determine which neural network parameters are to be used, obtained, or updated. By way of example, in FIG. 7, the user wishes to track the dog instead of the bicycle, and has therefore selected ANIMAL, BRIGHT, and MEDIUM, but he has made no selection for speed or trajectory since he may not know these for the dog. In cases where the user does not make a selection, the computation server 300 could return any library entry that fulfills the selections the user has made. Similarly, if there is no neural network parameter set in the library, the computation server 300 could follow any programmed routine to select from the library a parameter set suitable for the selections the user has made, or the UAV could simply continue with whatever its most recent or default parameter set is.

In another embodiment, context selection (with corresponding selection of the neural network parameters), need not be user-directed. As an alternative (or addition), the neural network 1000 and its controller 1100 (which may be integrated with the network 1000 itself) could include a “context selection” module 1190 in addition to an “operational neural network” (which controls flight operation according to a selected context and target). The context selection module 1190 may itself include a neural network, together with other types of routines, to determine what a current flight context is, so as to inform or even determine which context's neural network should be configured and run in the network 1000.

As just one example, assume that a user has been maneuvering her UAV so that some object has remained in the camera's field of view as the UAV moves. A neural network associated with the context selection module 1190 would be one mechanism to detect this. In other words, assume that some group of pixels appears to be moving at a rate slower than the pixels defining a large portion of the rest of the image the camera is capturing. This may indicate that the user is manually tracking the object defined by that group of pixels. The velocity and course of the UAV, which may be determined, for example, by the navigation module 1600, could then indicate if the object is moving FAST or SLOW, as well as STRAIGHT or CURVED, for example, and the size of the object relative to the total imaging area may indicate LARGE or SMALL. These factors may then indicate which context the UAV is currently being flown in.

Context selection could also be useful for stationary targets. For example, assume a user has been attempting to maneuver his UAV so as to hover over or circle around (“orbit”) an object that has a particular geometry. The user may not be skillful, however, or there may be wind making this maneuver too difficult for him. The attempt to hover or circle, with repeated return to a fixed position or a flight path, may be detected via the navigation module 1600 (the UAV seems always to remain or return to the same GPS coordinates within a chosen time period, for example), or using neural network techniques. A neural network, or other pattern-matching routine, may then be used to determine the geometry of the object over which the UAV has been attempting to hover or orbit. The context selection module 1190 may then also pass this information to the configuration module 1100, which could select an appropriate neural network configuration for directing flight control. In this case, the context selection module may thus be used as an aid to UAV station-keeping.

Such automatic context selection and flight control could occur automatically, for example, by executing code defining the context determination module 2290, or only after indication by a user to accept such automated tracking, for example, in response to an indication on the controller display that the UAV has detected potential deliberate tracking/hovering and queries whether the user wishes the UAV to assume autonomous tracking. This automated operation could be discontinued in any chosen method, such as simply sensing that the user has again begun to maneuver, for example, one of the joysticks 222, 224, to indicate he wishes to resume manual flight control.

FIG. 8 illustrates one example of how neural network parameters, either original or updated, can be pushed to a UAV either directly to a “terminal”, which may be either the controller (indirect pushing) or to a UAV itself (direct pushing) if the UAV is configured for direct communication. In the illustrated embodiment, it is assumed that there may be several servers (“nodes”) available for computational tasks, for example, in the “cloud” or otherwise networked. The procedure may involve both node data management 800 and computing node management 810, which may be embodied as executable code in any one of the servers 300, 310, 320, . . . , which may be designated as a primary or supervisory node.

Node data management 800 may involve such tasks as receiving and organizing input data (801) obtained from various application scenarios, various known network models and training methods (802). This data may need to be formatted and otherwise converted (803) for proper processing, at which point it will be ready for distribution to computing nodes (804) for actual computational processing.

Computing node management (810) may be implemented to optimize the use of computing resources such as load balancing (811), before the assigned nodes actually execute the computational tasks (812), for example, of computing neural network parameters. Once parameters have been computed, these may be returned to the node management or supervisory server to be transferred (“pushed”—850) to the terminal.

The terminal configuration software, included in either the controller 200, the UAV, or both, may be provided for performing terminal data management functions (860) such interacting with the node(s) and downloading and updating the network model and parameters (862), after which the corresponding neural network(s) of the UAV may be (re-)programmed, that is, (re-)configured (864) with the received parameters. To avoid possible run-time inconsistency, (re-)programming of a neural network in the UAV is preferably carried out only when the UAV is in a safe state, which may be indicated in any manner, such as directly by the user or as indicated by the UAV software itself, or by the controller 200.

Several of the components within the UAV 100 and controller 200 are either comprised of or include “software”, that is, computer executable code that is submitted to the processors for execution, along with conventional references to memory needed to fetch data used in execution of that code. Such executable code will itself be embodied within the storage devices of the respective systems. Furthermore, it is not necessary for all of the hardware and software (and/or firmware) components shown separately in the figures to be separate in practice; rather, any or all these may be implemented in single components.

As mentioned above, allowing the remote server 300 to perform the processor-intensive task of optimizing neural network parameters for different contexts has the advantages of greater flexibility, and also a reduced processing power requirement and/or less needed storage capacity within the controller and/or UAV. This enables great adaptability of the UAV's neural network 1000 even where the UAV is relatively light-weight, such as less than 2.0 kg, less than 1.5 kg, or even less than 1.0 kg. In another embodiment, the greater remote processing power is still leveraged, but need not be accessed via a network; rather, a vendor or other entity could make available neural network parameter “chips” or “cards”, that is, portable storage devices such as SD cards, flash drives, etc., which could contain remotely computed neural network parameters for different contexts, which may then be loaded into or made accessible to the controller for selective uploading to the UAV.

What is claimed is:

1. A method for controlling an unmanned vehicle comprising:
sensing a trigger event for updating a set of parameters of a remote neural network trained for a respective vehicle context of the unmanned vehicle;
receiving from a remote server a set of updated parameters of the remote neural network, wherein the set of updated parameters at least includes updated connection weights of the remote neural network; and
transmitting the updated connection weights to the unmanned vehicle, the unmanned vehicle being operable according to a vehicle-based neural network applying the updated connection weights.

2. The method of claim 1, further comprising:
transmitting to the remote server a set of observed data corresponding to the respective vehicle context for retraining the remote neural network using the set of observed data, wherein the updated connection weights comprise optimized weights of the retrained remote neural network.

3. The method of claim 1, wherein the set of observed data is imaging data captured by the unmanned vehicle.

4. The method of claim 1, wherein the set of updated parameters further includes updated neural network configuration parameters corresponding to a structure of layers and per-layer active nodes of the remote neural network.

5. The method of claim 1, further comprising:
displaying a plurality of contexts on a display;
sensing a user selection of one of the plurality of contexts; and
setting the user-selected context as the respective vehicle context.

6. The method of claim 1, further comprising:
displaying a real-time image on the display, wherein the real-time image is captured by and received from the unmanned vehicle;
sensing a user selection of an object displayed within the real-time image; and
automatically determining the respective vehicle context as a function of characteristics of the user-selected object.

7. The method of claim 1, further comprising automatically determining the respective vehicle context from sensed operational characteristics of the unmanned vehicle.

8. The method of claim 1, wherein the unmanned vehicle includes a plurality of different neural networks, the method further comprising:
initializing the plurality of different neural networks to correspond to different respective vehicle contexts.

9. The method of claim 1, further comprising:
determining a current operational context of the unmanned vehicle; and
uploading the updated connection weights of a vehicle context corresponding to the current operation context to be applied to the vehicle-based neural network.

10. The method of claim 1, wherein the trigger event is a reception of out-of-bounds context data from the unmanned vehicle or a reception of an update command.

11. A controller for an unmanned vehicle configured to:
sense a trigger event for updating a set of parameters of a remote neural network trained for a respective vehicle context of the unmanned vehicle;
receive from a remote server a set of updated parameters of the remote neural network, wherein the set of updated parameters at least includes updated connection weights of the remote neural network; and
transmitting the updated connection weights to the unmanned vehicle, the unmanned vehicle being operable according to a vehicle-based neural network applying the updated connection weights.

12. The controller of claim 11, further comprising a data transmission arrangement configured to transmit to the remote server a set of observed data corresponding to the respective vehicle context for retraining the remote neural network using the set of observed data, wherein the updated connection weights comprise optimized weights of the retrained remote neural network.

13. The controller of claim 11, further configured to receive imaging data captured by the unmanned vehicle as the set of observed data.

14. The controller of claim 11, further comprising an update module configured to receive neural network configuration parameters corresponding to a structure of layers and per-layer active nodes of the remote neural network from the remote server.

15. The controller of claim 11, further comprising:
a display configured to display a plurality of contexts;
a context determination module configured to sense a user selection of one of the plurality of contexts and to set the user-selected context as the respective vehicle context.

16. The controller of claim 11, further comprising:
a display configured to display a real-time image captured by and received from the unmanned vehicle; and
a context determination module configured to sense a user selection of an object displayed within the real-time image and to automatically determine the respective vehicle context as a function of characteristics of the user-selected object.

17. The controller of claim 11, further comprising a context determination module configured to automatically determine the respective vehicle context from sensed operational characteristics of the unmanned vehicle.

18. The controller of claim 11, wherein the unmanned vehicle includes a plurality of different neural networks, the controller further comprising an update control module configured to initialize the plurality of different neural networks to correspond to different respective vehicle contexts.

19. The controller of claim 11, further comprising a context determination module configured to determine a current operational context of the unmanned vehicle, and an update control module configured to upload the updated connection weights of a vehicle context corresponding to the current operational context to be applied to the vehicle-based neural network.

20. The controller of claim 11, wherein the trigger event is a reception of out-of-bounds context data from the unmanned vehicle or a reception of an update command.
